(19) United States
(12) Patent Application Publication
(10) Pub. No.: US 2004/0034625 A1
(43) Pub. Date: Feb. 19, 2004

(54) Method and system for complex boolean queries using a simple and intuitive graphical user interface search bar

(76) Inventor: Kris Reddy, Plano, TX (US)

Correspondence Address: Richard K. Robinson, North Dallas Bank Tower, Suite 575, 12900 Preston Road, LB-41, Dallas, TX, 75230, US

(21) Appl. No.: 10/223,397

(22) Filed: Aug. 19, 2002

(51) Int. Cl. G06F 7/00

(52) U.S. Cl. 707/3

(57) ABSTRACT

A data processing system that includes a data store, means for storing information within the data store, and a graphical user interface is disclosed that uses a novel query system. The query system includes Search Bar, with laterally aligned search cells. The Search Bar allows a user to perform any search on single or multiple cells available in the Search Bar. Each cell allows a user to enter one or more characters to identify specific words starting with these character(s) or specific words containing these character(s). Each character entered narrows or broadens the search results.

### BACKGROUND OF THE INVENTION

1. Technical Field

The present invention relates, generally, to a data processing system using a graphical interface and, more particularly, to a graphical user interface by which a user may perform query searches that automatically include boolean operators. More specifically still, the present invention relates to a graphical user interface that allows a user to obtain an instant feedback of the search results.

2. Description of the Related Art

Data processing systems having large data storage or memory are well known in the art. Graphical user interfaces have been provided with these data processing systems to lessen the requirement that the user be “computer literate”. Graphical user interfaces allow a user to retrieve and manipulate data merely by positioning a pointing device, such as a mouse icon, on a desired operand icon and open an application or retrieve a file by clicking the mouse.

In order to perform searches or queries within a system that manages and stores information, traditional methods for construction complex information queries typically require an understanding of how to use boolean logic and operations and the particularities of different search engines. A user who does not understand boolean logic will typically waste an inordinate amount of time before obtaining the desired results.

U.S. Pat. No. 5,842,203 discloses: “A data processing system that includes a data store, means for archiving files within the data store, and a graphical user interface is disclosed that uses a novel query system. The query system includes a domain scope control field, a narrowing search control funnel, a specific item search field, and a broadening search control funnel. The domain scope control field allows a user to perform a hierarchical search within a plurality of topics available in the domain control field. The search query generates a search cell. The narrowing search control allows a user to narrow the scope of the search cell. The specific item search field allows a user to identify specific key words to be searched within the search cell. The broadening search control allows a user to broaden the scope of the search cell.”

However, simplifying boolean operations does not solve all of the problems. Proper spelling of key words and names used in the search operation posses a time consuming problem. There are software programs such as that used by legal research service providers that helps solve the proper key word and name spelling problem.

FIG. 2 illustrates an example of a prior art legal search interface 100. The legal search interface 100 includes 11 searchable fields 61-71, one control field 72, and two display fields 73 and 74. In the example shown, searchable field 61 searches docket numbers, searchable field 62 searches for the parties attorney's name, searchable field 63 searches for the cite, searchable field 64 searches for the plaintiff's name, searchable field 65 searches for the defendant's name, searchable field 66 searches for the court that heard the case, searchable fields 67, 70 and 71 are unassigned, searchable field 68 searches for the case name, and searchable field 69 searches the judges' name that heard the case. Display field 73 displays the item in the field having the last entry. For example, the cite field 63 had 170 entered into it. Display field 73 displays the number 170. The display would have grown starting with the number 1 followed by 17 and then 170 as these characters are entered into the cite field 63. Prior to the entry of 170, the letters “geo” were entered in the plaintiff's name field, character by character with other names having similar spelling being displayed in the display field. Thus, the user can select the proper spelled keyword by clicking on that keyword when displayed in the display field 73. Scroll arrows 75 and 76 allows the display 73 to scrolled the stored data to locate the searched for data.

A result is shown in result display 74. In display 74 there were 300 plaintiffs whose name began with “geo” identified and 120 cases having a cite beginning with 170 found. However, the boolean combination shown in the result display 74 identifies 20 cases having both of the entries. A control field 72 when clicked on will replace the display of FIG. 2 with a listing of the 20 cases.

The above described prior art systems represent significant advancement in the graphic user interfaces. However, both, as with other prior art systems, require learned skills and are time consuming when used, and do not provide an instant feedback of the search results.

### SUMMARY OF THE INVENTION

A data processing system that includes a data store, means for storing information within the data store, and a graphical user interface is disclosed that uses a novel query system. The query system includes Search Bar, with laterally aligned search cells. The Search Bar allows a user to perform any search on single or multiple cells available in the Search Bar. Each cell allows a user to enter one or more characters to identify specific words starting with these character(s) or specific words containing these character(s). Each character entered narrows or broadens the search results.

It is therefore an object of the present invention to provide a data processing system using a graphical interface.

It is another object of the present invention to provide a graphical user interface by which a user may perform query searches and obtain instant feedback of the search results.

### BRIEF DESCRIPTION OF DRAWINGS

FIG. 1 illustrates a representative hardware environment which illustrates a typical hardware configuration of a work station;

FIG. 2 illustrates a prior art graphical user interface;

FIGS. 3A-3C illustrate an embodiment of a graphical user interface according to the invention;

FIG. 4 illustrates a text searchable embodiment of the invention;

FIGS. 5A-5B illustrate a flow diagram of a search routine useable with the embodiment of FIG. 4; and

FIGS. 6-9 are examples of the practice of the invention.

### DETAILED DESCRIPTION OF THE PREFERRED EMBODIMENT

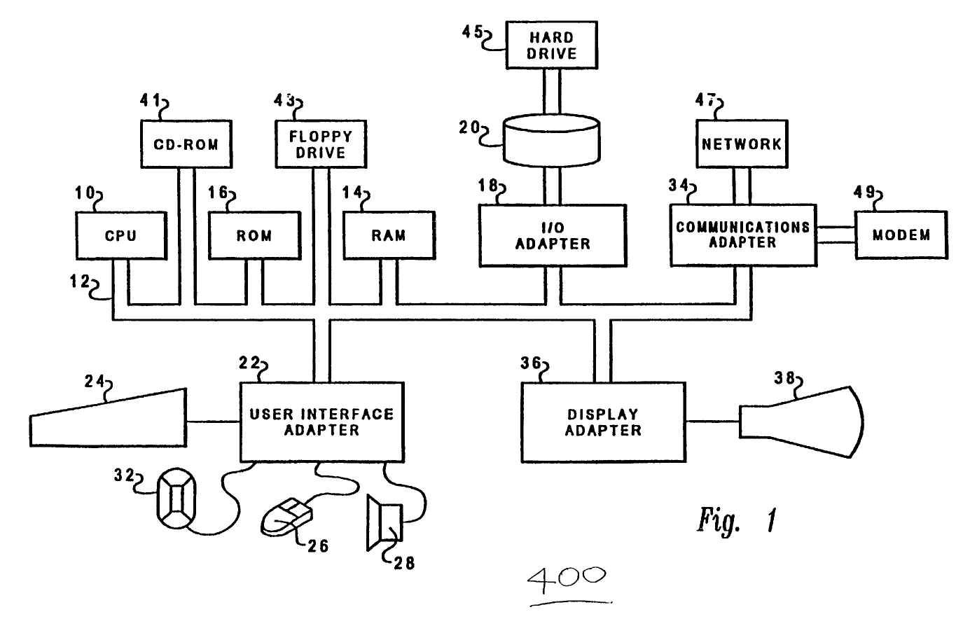

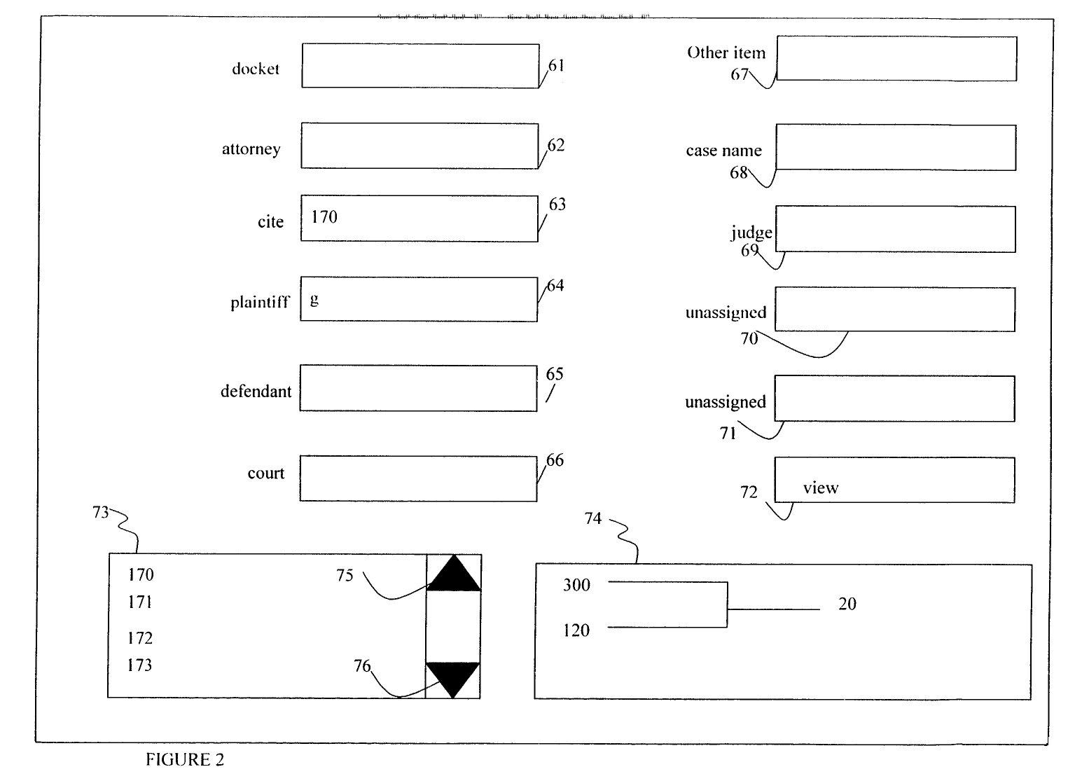

The invention is preferably practiced in the context of the operating system resident on a standard computer system used in homes, businesses and hand held units. A representative computer system 400 is shown in FIG. 1, and at least includes a central processing unit 10, and a number of other units interconnected via a system bus 12. The other interconnected units includes Random Access Memory (RAM) 14, Read Only Memory (ROM) 16, and I/O adapter 18, for connecting peripheral devices such as disk units 20 to the bus 12, a user interface adapter 22 for connecting a keyboard 24, a mouse 26, a speaker 28, a microphone 32, and/or other user interface devices such as a touch screen device (not shown), a communication adapter 34, and a display adapter 36, for connecting the bus to a display device 38. Other peripheral devices may include non-writable storage media (e.g. read only memory devices within a computer such as ROM 16 or CD-ROM disks 41 readable by a computer I/O attachment), writable storage media (e.g. floppy disks 43 and hard drives 45), or communication media such as network 47 and telephone networks via a modem 49. All of the non-writable storage media can be accessed and searched according to the below described methods and are collectively referred to as storage hereinafter. The computer system 400 has resident there in a base operating system and the computer software making up this invention, which is included as a tool kit.

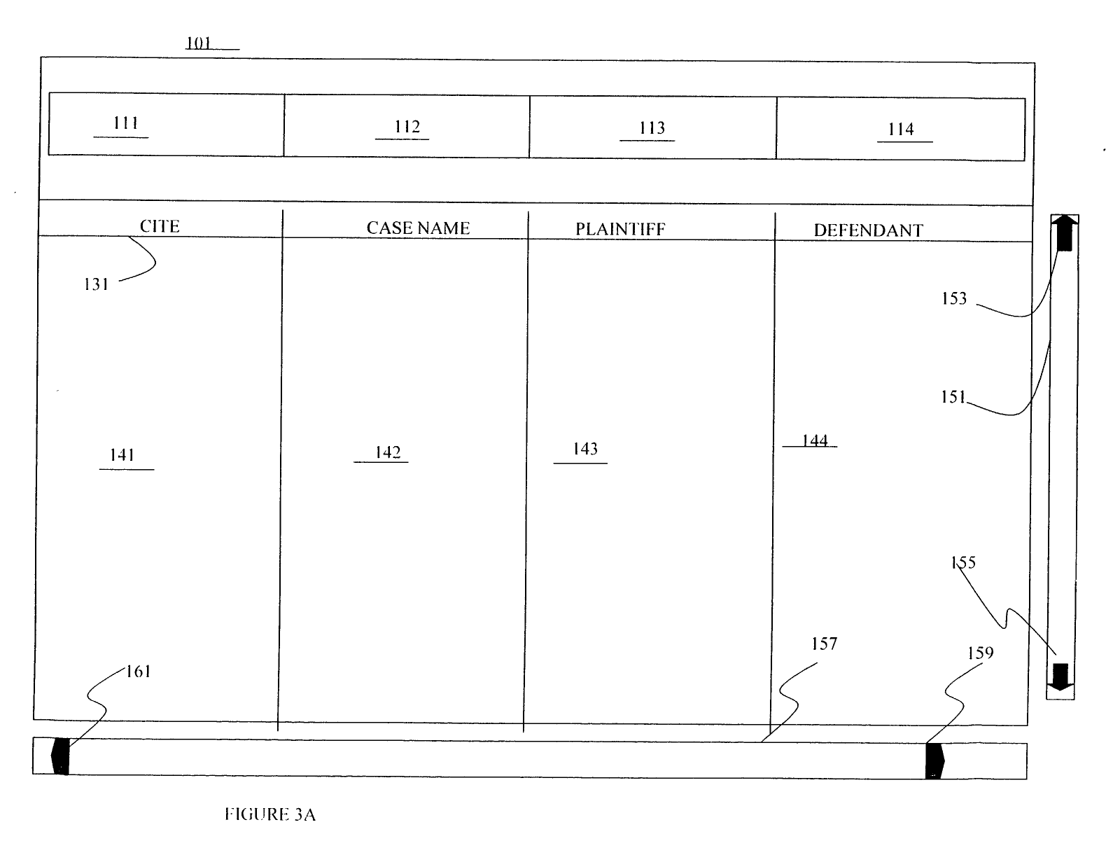

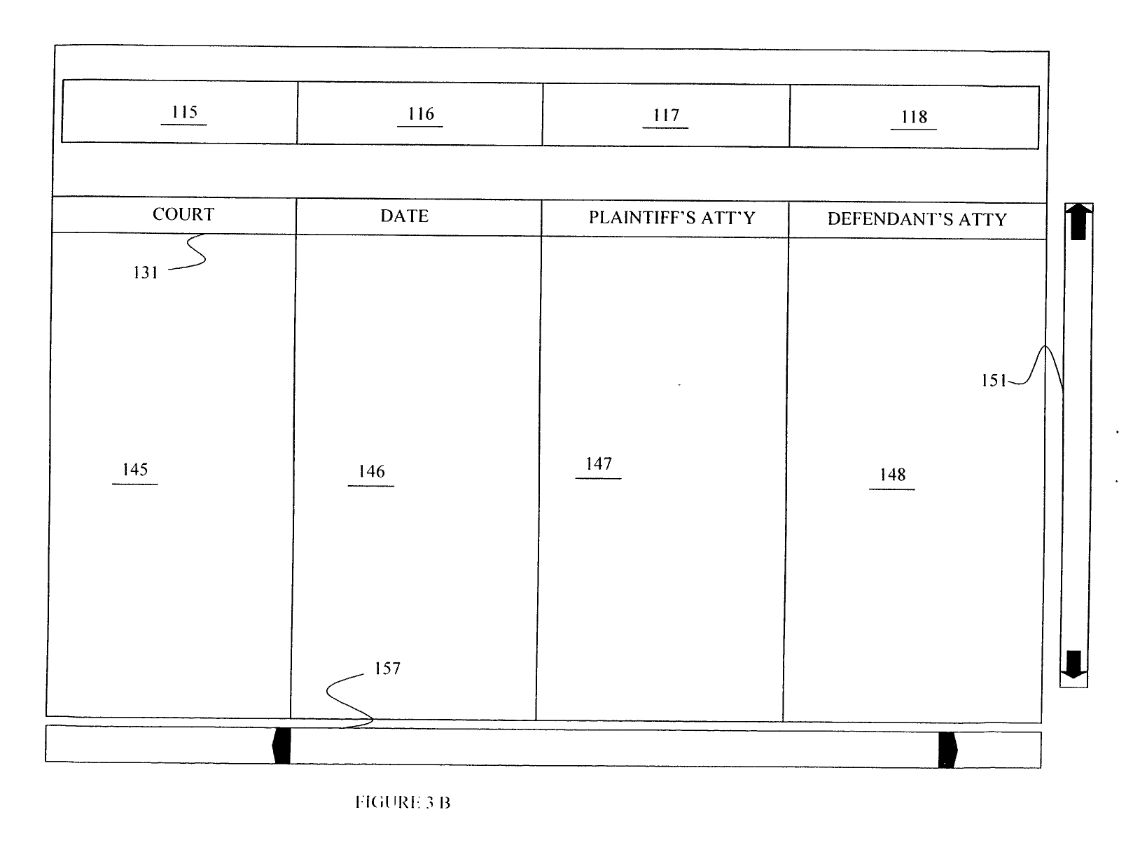

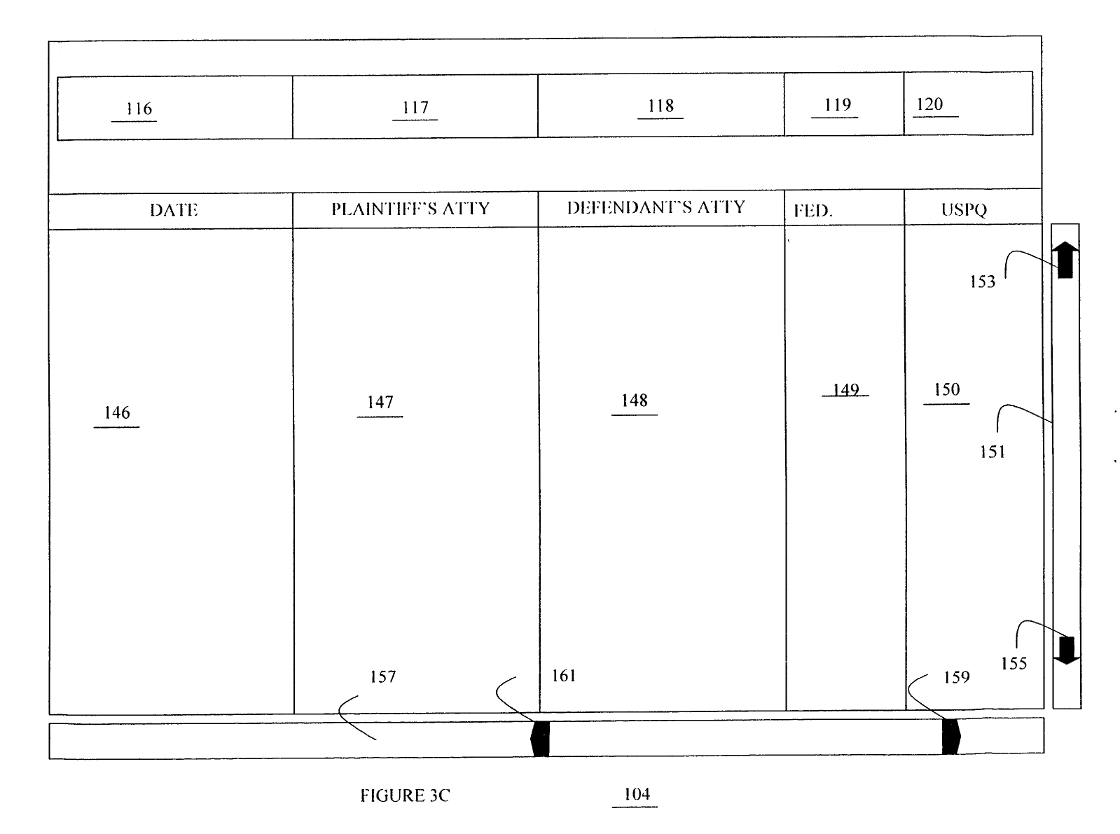

The computer system 400 will utilize a search or query engine that allows an end user to perform query searches in stored data that can include address books, archive documents, such as articles, graphical images, computer movies, or other types of data arranged into files. The implementation and operation of the query search engine is illustrated in FIGS. 3 through 9.

Referring to FIG. 3, there is shown a graphical interface display 101 that provides for a searchable legal data base. The graphical interface is arranged in columns of searchable categories and displays and rows where each row is related to the same address books, archive documents, such as articles, graphical images, computer movies, or other types of data arranged into files. A search bar 110 includes searchable cells 111 through 120. The data stored in the storage of FIG. 1 can be categorized at the user discretion. In the embodiment of FIG. 3 each searchable cell has a corresponding category name displayed beneath it in name field 131. When searched, as one or more alpha numerical characters are entered in one of the searchable cells 111-120, the retrieved data will be displayed in the displays 141 through 150 that matches each category. In the embodiment shown in FIG. 3a, searchable cell 111 is used by entering characters, such as that found on the standard alpha-numerical keyboard, to search data stored in the storage of FIG. 1 according to its citation and display the results matching the characters entered into the searchable cell 111 on display 141 as well as the related results of the other categories in displays 142 through 150. Similarly, searchable cell 112 is used to search the stored data according to the case name and display the data matching the characters entered into the searchable cell 112 on display 142; searchable cell 113 is used to search the stored data according to the plaintiff's name and display the data matching the characters entered into the searchable cell 113 on display 143; and searchable cell 114 is used to search the stored data according to the defendant's name and display the data matching the characters entered into the searchable cell 114 on display 144. In all cases the related results are also displayed according to their categories regardless of the searchable cell used. For example, entering the characters “geo” in searchable cell 112 will not only result in all of the cases having a name that begins with the entered characters being displayed in a column in display 142 but their cites are displayed in a column in display 141, the plaintiffs name in are displayed in a column in display 143 etc such that all stored information is displayed according to its category in the same row for each case. The column arrangement of the retrieved date can be either numerical or alphabetical in either ascending or descending order.

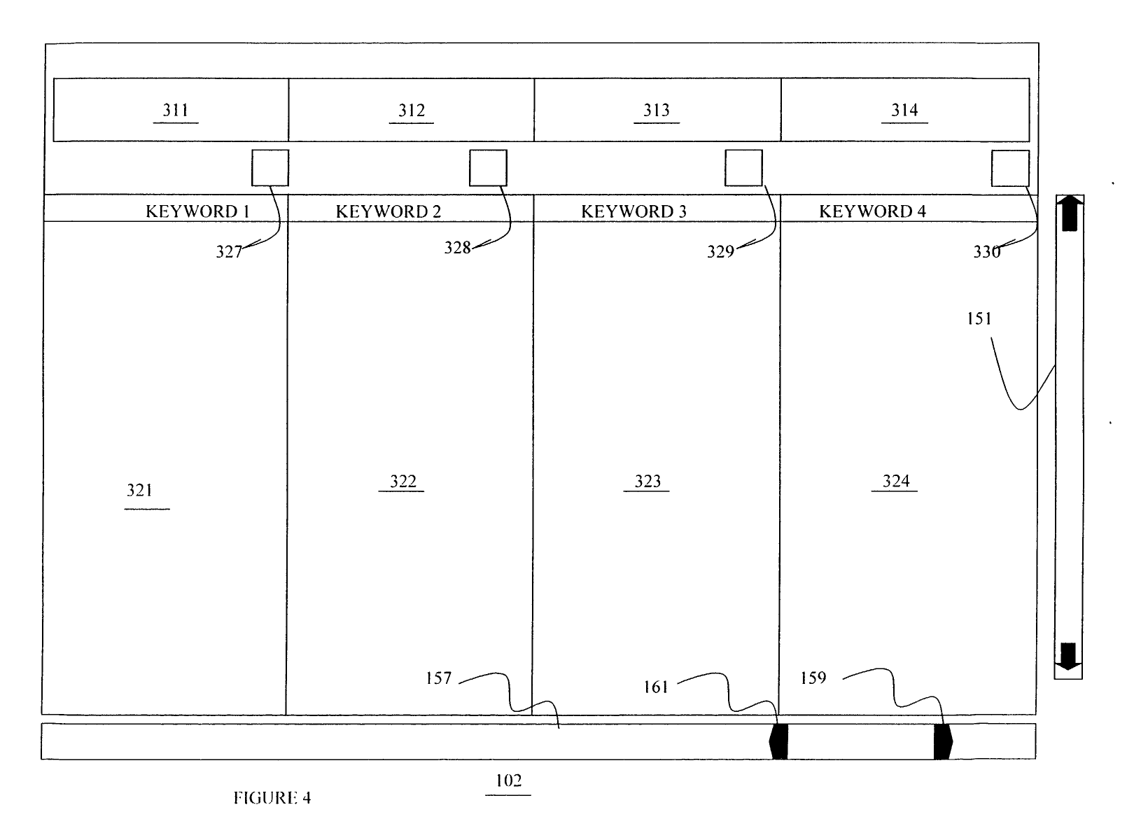

Lateral scroll bar 157 can be used to scroll the image 101 by repositioning of the arrows 161 and 159 so as to display the images of FIGS. 3b, 3c and 4. The arrows may be used to relocate the images in either direction. Referring to FIG. 3b, searchable cell 115 is used to search data stored in the storage of FIG. 1 according to the ruling court and display the data matching the characters entered into the searchable cell 115 on display 145; searchable cell 116 is used to search the stored data according to the date of the court's ruling and display the data matching the characters entered into display 146; searchable cell 117 is used to search the stored data according to the plaintiff's attorney's name and display the data matching the characters entered on display 147; and searchable cell 118 is used to search the stored data according to the defendant's attorney's name and display the data matching the characters entered on display 148. As previously discussed, the entering of a character in one searchable cell will result in all the categorized information being display in the same row for each retried case resulting from the entering of the character.

Relocating the lateral scroll bar 159 will shift the image 102 or 103 over one display at a time. See FIG. 3c where the image 104 has new displays 149 and 150 and does not show the display 145 of FIG. 3b. Control cells 119 and 120 allow the user to select a data base to search. When control cell 119 is selected the search is made in the Federal Reporter series and when control cell 120 is selected then the search is made in the USPQ series. Selection of both control cells will result in both series being search. The displays 149 and 150 shows the corresponding selected data base or bases.

FIG. 4 illustrate an optional feature for searching embedded text using advance boolean techniques. The display 102 of FIG. 4 may be reached by an advance button (not shown) or by laterally scrolling with the lateral scroll bar 157. The display 102 has a row of searchable cells 311 through 314, a title row 131, boolean operators 327 through 330 and display columns 321 through 324. Although only 4 keywords are shown the number can be selected to fit the application. The entering of letters of a first key word in the searchable cell 311 and selecting a boolean operation with the button 327 to combine the entered key word with a second text key word entered in the searchable cell 316, will result in documents having the resulting combination being displayed in all the display fields. The retrieved result can further be narrowed by selecting the boolean function with button 328 and combining the search results with a third entry in searchable cell 313. This process may be repeated until the desired information is retrieved. Result fields 341 through 350 and 321 through 324 provides instant feedback of the results with each character that is entered is in the searchable cells.

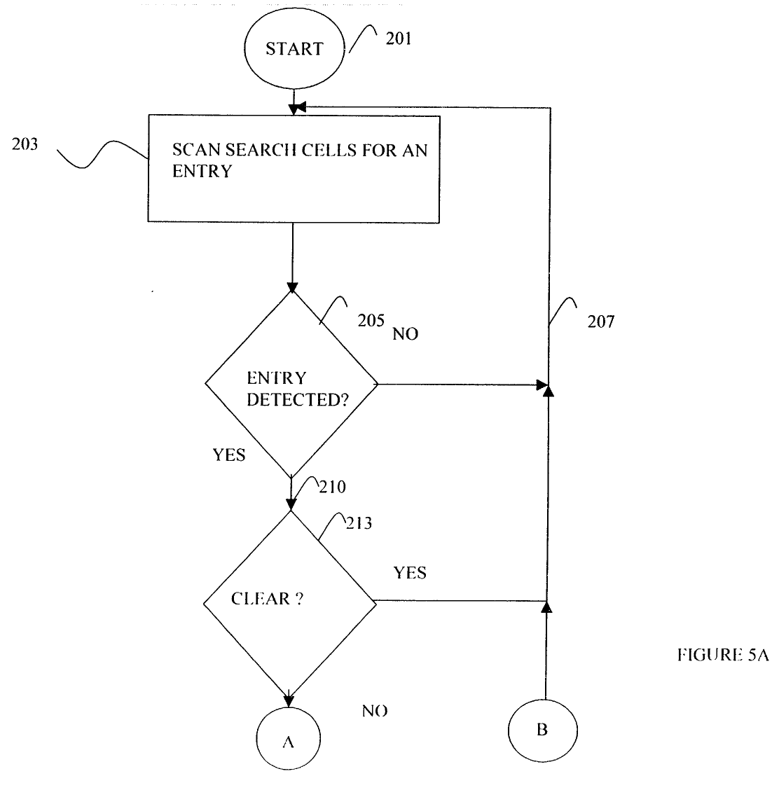

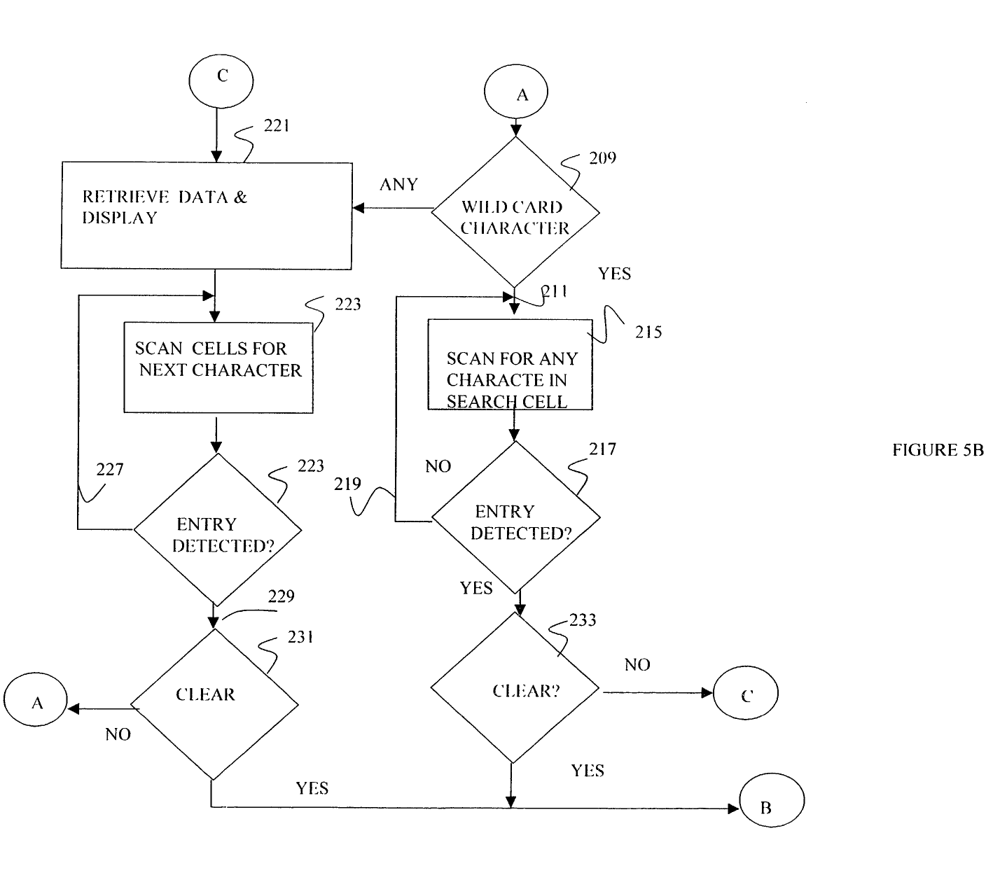

In FIG. 5, there is shown a flow chart representing the program used to search the data bases. Starting with the start 201, the computer system 400 of FIG. 1 searches the search cells for an entry such as a key stroke from the key board 24 at block 203, decision diamond 205 and the no path 207 which is taken until an entry is detected. When an entry is detected the yes path 210 is taken to the decision diamond 213 where a check is made to see if the entry was a clear. If the entry was a clear the return path 207 is taken to block 203. If the entry was not a clear the path through connector A is taken to FIG. 5B. The A connector on FIG. 5B connects to decision diamond 209 where a check is made to see if the entry was a wild card character. In the embodiment of FIG. 5, the wild card character is the character. However, any character may be used.

The entries in the searchable cells 111 through 118 form key words. Each entry represent a sequential entry of the letters in the key word of the cell in which it is entered. If the wild card character is selected then the search of the key word of the cell having the wild card character will be based on the following letters being located anywhere in the key word instead of the normal sequential arrangement of starting with the first letter of a key word followed by the sequential letters.

The path taken when a wild card character is detected is the yes path 211 is taken to block 215 where a scan is made for any character in the cell being searched and the process is repeated via decision diamond 217 and the no path 219 until an entry is detected at decision diamond 217. When an entry is detected the yes path is taken to decision diamond 233 where a check is made to see if the detected entry was a clear. If it was a clear then the system 400 returns to FIG. 5A via connector B to Block 203.

Returning to decision diamond 209, regardless if a wild card character is detected or not, the any path connects the decision diamond 209 to the retrieve data and display block 221. At block 221 all of the displays 141 through 150 display the information corresponding to the entered letter or letters retrieved from storage and display the information under the corresponding cells and titles.

At block 223 a scan is made for the next entry. Decision diamond 223 and return path 227 circulates the computer system 400 until an entry is detected at which time the yes path 229 is taken to see if a clear was entered at decision diamond 231. If the clear was entered then the system 400 returns to FIG. 5A via connector B to Block 203. The no path returns via connector A the computer system 400 to decision diamond 209 for a check for a wild card.

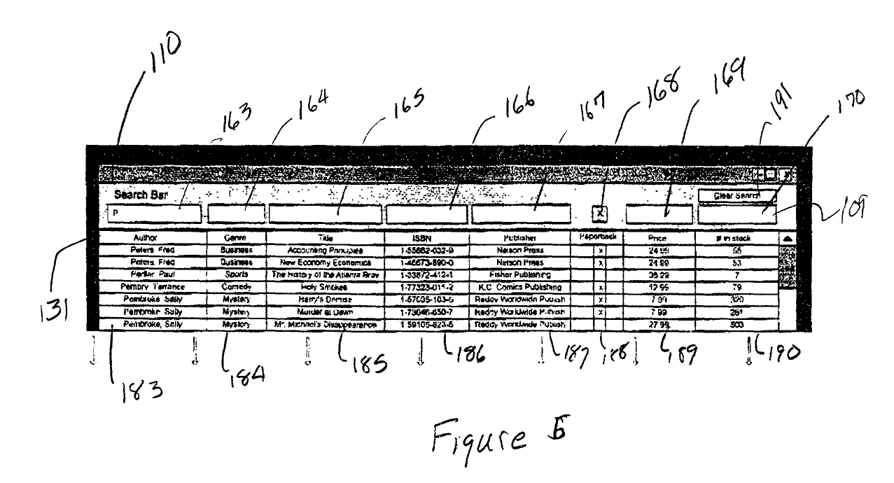

FIG. 6 depicts a graphical user interface image having a Search Bar 110 according to the present invention. Search Bar 110 further comprises search cells 163 through 170. Search Bar 110 further includes a Clear Search Button 191 and as was previously discussed the Clear Search Button 191 clears the display and the computer system 400 to exit from the search routine. Each search cell 163 through 170 has a title field 131 that represents the category of key word(s) being search in the search cell. In alignment with and beneath each search cell 163 through 170 is a result viewing field 183 through 190. There is a vertical scroll bar 151 that allows the scrolling of the result viewing field 183 by clicking on the up arrow 153 or the down arrow 155 shown in FIG. 3.

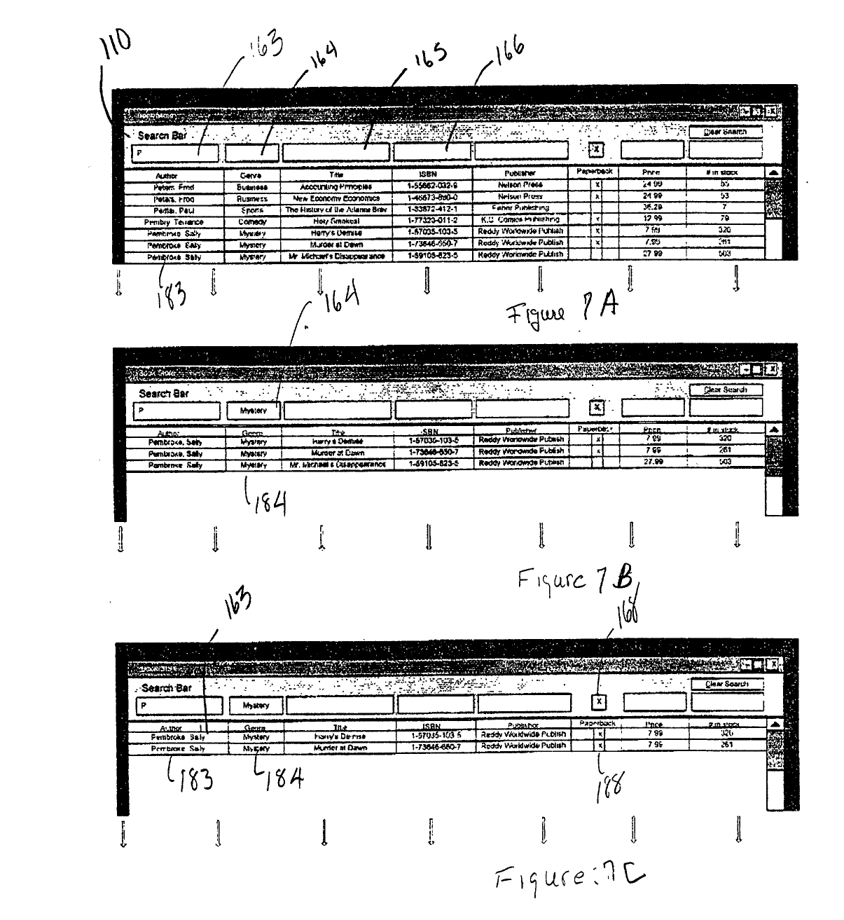

FIGS. 7 through 9 provide examples of a literature search using the embodiment of FIG. 6. In the example a search is made to list all of the book written by authors whose name began with the letter “P”. A “P” is entered in the author search cell 163 and the names of authors in the storage have a name that began with the letter P are displayed in the result viewing field 183. As additional characters are entered in the same search cell 163 then the search results viewing area 183 through 190 will list books whose author's name contain the same characters that were entered in the author's search cell 163 and so on.

FIGS. 7 through 9 depicts searches where the search criteria is entered in two or more members of the search cells 163 through 170. For example in FIG. 7B search criteria in genre 164 and the author's name in search cell 163 in FIG. 7A. The corresponding search results are displayed in the search results areas 183 through 190. As additional characters are entered in the author's search cell 163, the search results are shown in the search results areas 183 through 190. As additional characters are entered in the genre search cell 164, the results in the search results areas 183 through 190 become further refined in accordance with this additional search criteria entered.

The search bar 110 may also contain search cells 168 that are based on yes and no statements. Cell 168 is a control cell and allows for the selection of only paper back books, hard cover books or both. If checked only paperback books will be selected, if unchecked non-paperback books will be selected and if grayed both types of books are selected.

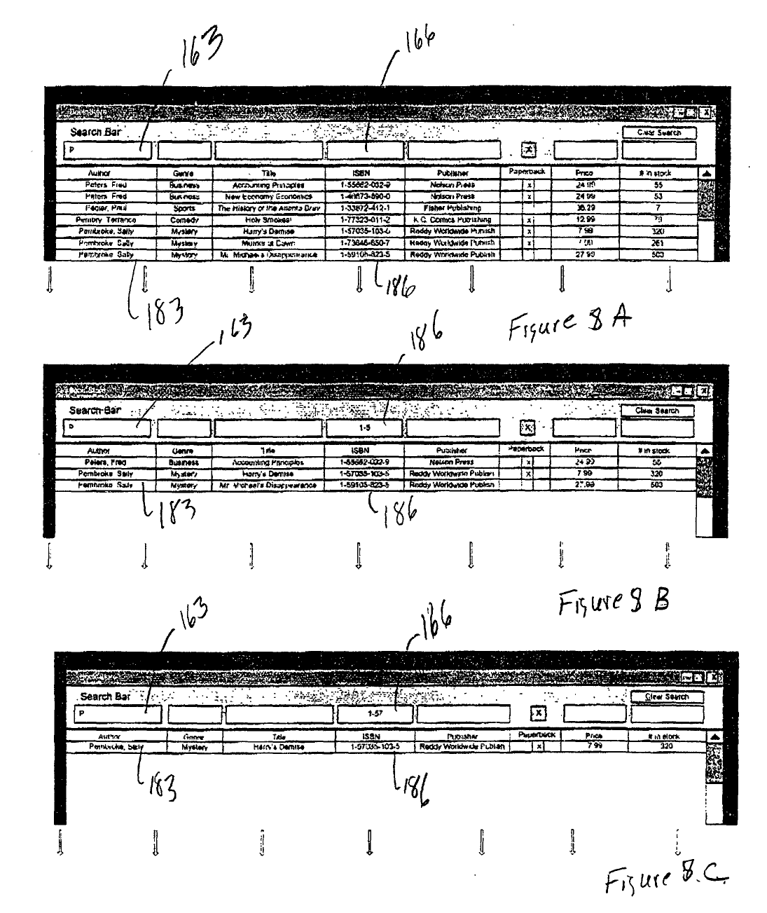

FIG. 8 are an example of a search where author's names beginning with the letter P are combines with the selection of hard cover books in control cell 168 to locate the desired book.

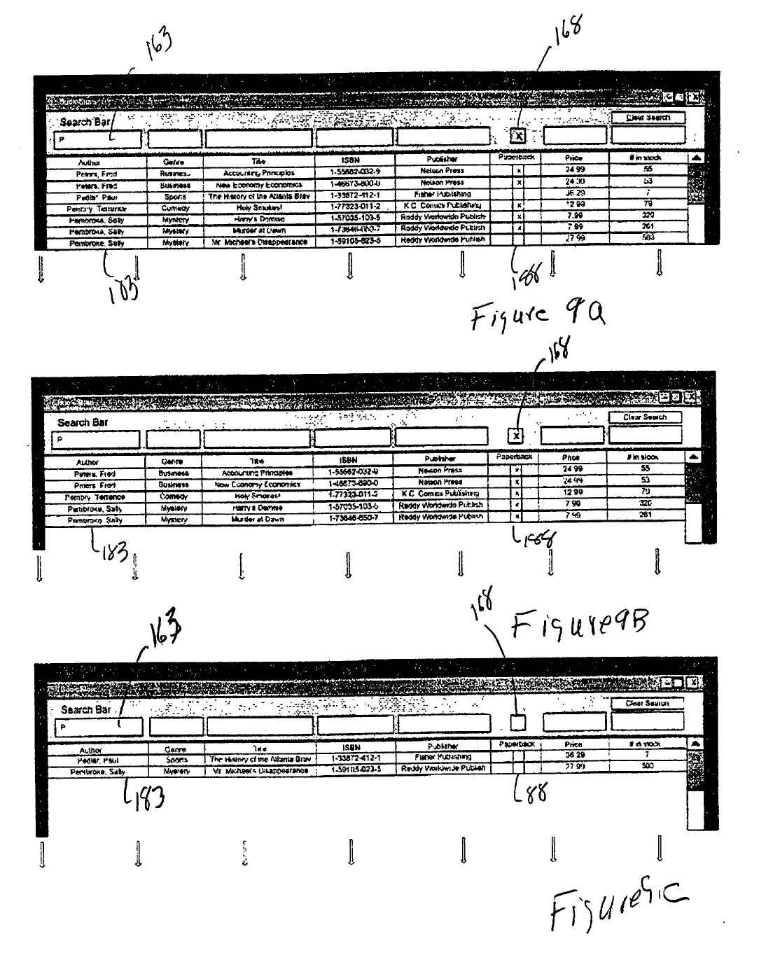

Regardless of whether the user is searching in a single search cell or multiple search cells as each character of a search is entered, the results will continue to be refined. FIG. 9 are an example of a search where author's names beginning with the letter P are combines with the ISBN number in cell 166 to locate the desired book.

I claim:

1. In a data processing system, including a data store having data stored therein according to predefined categories and a graphical user interface, the graphical user interface comprises:
a plurality of graphically displayed search cells for graphically specifying a search query, each search cell of the plurality of graphically displayed search cells being capable of representing a category of search parameters;
means for selecting a search cell from the plurality of graphically displayed search cells for making an entry into;
means for making entries into the selected search cell; and
a plurality of graphically displayed search result cells for displaying a result of the search query, each search result cell of the plurality of graphically displayed search cells being in alignment with a member the plurality of graphically displayed search cells such that as an entry is made into a search cell the search results are displayed in categorical alignment with the members of the plurality of graphically displayed search cells.

2. The data processing system according to claim 1 wherein when each entry is made, a name of an element of the category being searched is sequentially spelled out one character at a time and the search results displayed in categorical alignment with the members of the plurality of graphically displayed search cells as each character is entered.

3. The data processing system according to claim 2, wherein one entry may be a wild card character and when a wild card entry is made any following entries may be located anywhere in the name of the element of the category being search.

4. The data processing system according to claim 1, wherein a first member of the plurality of graphically displayed search cells provides for a classification category, the classification being selectable by a single entry to the first member.

5. The data processing system according to claim 1, with a first member and a second member of the plurality of graphically displayed search cells representing embedded text search categories and the plurality of graphically displayed search cells further include at least one boolean function cell for performing a boolean combination of the first member with the second member.

6. The data processing system according to claim 5, wherein the boolean combinations are selectable.

7. The data processing system according to claim 1, wherein the plurality of graphically displayed search result cells represents the boolean combination of each member of the plurality of graphically displayed search cells with all remaining members of the plurality of graphically displayed search cells.

8. The data processing system according to claim 1, wherein the graphical user interface includes a display means for displaying the plurality of graphically displayed search result cells and the plurality of graphically displayed search cells and wherein there being N members of the plurality of graphically displayed search result cells and with all members being in lateral alignment from a first search member to the N^{th}. search member and similarly, there also being N members of the plurality of graphically displayed search result cells and with all members being in lateral alignment from a first result member to the N^{th}. result member, the graphical user interface further comprises a scroll means for scrolling between the first search and result members and the N^{th} search and result members.

9. A graphical user interface comprises a data processing system including:
means for displaying a plurality of graphically displayed search cells for graphically specifying a search query, each search cell of the plurality of graphically displayed search cells being capable of representing a category of search parameters;
means for selecting a search cell from the plurality of graphically displayed search cells for making an entry into;
means for making entries into the selected search cell; and
means for displaying a plurality of graphically displayed search result cells for displaying a result of the search query, each search result cell of the plurality of graphically displayed search cells being in alignment with a member the plurality of graphically displayed search cells such that as an entry is made into a search cell the search results are displayed in categorical alignment with the members of the plurality of graphically displayed search cells.

10. The graphical user interface according to claim 9, wherein when each entry is made, a name of an element of the category being searched is sequentially spelled out one character at a time and the search results displayed in categorical alignment with the members of the plurality of graphically displayed search cells as each character is entered.

11. The graphical user interface according to claim 10, wherein one entry may be a wild card character and when a wild card entry is made any following entries may be located anywhere in the name of the element of the category being searched.

12. The graphical user interface according to claim 9, wherein a first member of the plurality of graphically displayed search cells provides for a classification category, the classification being selectable by a single entry to the first member.

13. The graphical user interface according to claim 9, with a first member and a second member of the plurality of graphically displayed search cells representing embedded text search categories and the plurality of graphically displayed search cells further include at least one boolean function cell for performing a boolean combination of the first member with the second member.

14. The graphical user interface according to claim 13, wherein the boolean combinations are selectable.

15. The graphical user interface according to claim 9, wherein the plurality of graphically displayed search result cells represents the boolean combination of each member of the plurality of graphically displayed search cells with all remaining members of the plurality of graphically displayed search cells.

16. The data processing system according to claim 9, wherein the graphical user interface includes a display means for displaying the plurality of graphically displayed search result cells and the plurality of graphically displayed search cells and wherein there being N members of the plurality of graphically displayed search result cells and with all members being in lateral alignment from a first search member to the N^{th}. search member and similarly, there also being N members of the plurality of graphically displayed search result cells and with all members being in lateral alignment from a first result member to the N^{th} result member, the graphical user interface further comprises a scroll means for scrolling between the first search and result members and the N^{th} search and result members.
